(19) United States
(12) Patent Application Publication
(10) Pub. No.: US 2025/0255227 A1
(43) Pub. Date: Aug. 14, 2025

(54) INDOOR AGRICULTURAL AUTONOMOUS VEHICLE, SYSTEM AND METHOD

(71) Applicant: VISCON GROUP HOLDING B.V., 's-Gravendeel (NL)

(72) Inventors: Ysalis MALLÉDANT, Delft (NL); Bart VAN DUIJN, Delft (NL); Kushal THIRANI, Delft (NL)

(73) Assignee: VISCON GROUP HOLDING B.V., 's-Gravendeel (NL)

(21) Appl. No.: 18/857,587

(22) PCT Filed: May 19, 2023
(86) PCT No.: PCT/NL2023/050284

§ 371 Date: Oct. 17, 2024

(30) Foreign Application Priority Data
May 23, 2022 (NL) 2031967

(51) Int. Cl. A01G 9/26; B25J 5/00; B60L 15/38; B60L 50/60; B60L 53/124; B60L 53/38; G05D 1/244; G05D 1/247; G05D 101/00; G05D 107/20

(52) U.S. Cl. CPC A01G 9/26; B25J 5/007; B60L 15/38; B60L 50/60; B60L 53/124; B60L 53/38; G05D 1/244; G05D 1/247; B60L 2200/40; B60L 2240/62; G05D 2101/22; G05D 2107/21

(57) ABSTRACT

An autonomous vehicle for autonomous navigation in an agricultural indoor environment includes an energy storage unit for storing electrical energy, a motor for moving the autonomous vehicle through the agricultural indoor environment using energy from the energy storage unit, and a wireless charging unit for charging the energy storage unit. The wireless charging unit is configured to wirelessly receive energy from an external charging station. A localizing unit is configured to generate data to update the localization of the autonomous vehicle within the agricultural indoor environment based on the known location of the charging station.

The present invention relates to wirelessly charging autonomous vehicles for autonomous navigation in an agricultural indoor environment, in particular wirelessly charging autonomous mobile robots for greenhouses, associated systems and methods of operating such.

Automated Guided vehicles (AGVs) have been widely used in automatized industrial environments like factories or warehouses. Such vehicles are guided typically by a wire and are thus non-autonomously navigating. A recent and promising trend in the modern industry and logistics concerns autonomous (non-guided) vehicles, often referred to as autonomous mobile robots (AMR). AMR have the capability to navigate autonomously through their environment, where AGV are limited to fixed routes. AGV are designed for one application and in that sense suited for traditional business models whereas AMR offer flexibility through reprogramming and are thus suited for agile businesses. The energy systems used yet to be a major limitation of autonomous vehicles. With the introduction of wireless charging, new logistic processes have however been made available. Wireless charging enables an efficient energy transfer and an easy integration without heavy infrastructure changes. Wireless charging is also wear and maintenance free.

In the specific field of indoor agriculture, like greenhouses and vertical farming, the desirability of autonomous vehicles has been rendered very high to overcome the bottleneck of labor restricting the scalability of food productions of these modern agricultural techniques and the need for more flexible, efficient logistics systems. Yet retrofitting existing agricultural environments in an efficient manner and improving the accuracy of position control of such autonomous vehicles to allow for high-productivity crop production remain unsolved issues.

An object of the invention, next to other objects, is to solve the above-mentioned problems of the prior art.

According to an embodiment, an autonomous vehicle for autonomous navigation in an agricultural indoor environment is provided. The autonomous vehicle comprises an energy storage unit for storing electrical energy, a motor for moving the vehicle through the indoor environment using energy from the energy storage unit, a wireless charging unit for charging the energy storage unit, the wireless charging unit being configured to wirelessly receive energy from an external charging station, and a localizing unit configured to generate data to update the localization of the vehicle within the indoor environment based on the known location of the charging station.

In this way, the autonomous vehicle combines efficiently wireless charging and navigation update. Based on the pre-established knowledge of the location of the charging station(s), an update of the localization of the vehicle is possible when the vehicle is at the charging station. This implies that the retrofitting of the agricultural indoor environment can be simplified to the retrofitting of charging stations used both for wireless charging and for navigation purposes.

According to a preferred embodiment, the localizing unit is configured to receive information from the wireless charging unit related to the localization of the vehicle in the indoor environment with respect to the charging station. In this way, the wireless charging unit may be reused for navigation update, reducing thus the costs by incorporating two functions into one unit and also achieving a high accuracy of positioning.

According to a preferred embodiment, the localizing unit comprises a power sensing unit configured to sense the amount of electrical power or the strength of the magnetic field received by the wireless charging unit and to generate, based on the sensed power or magnetic field, data related to the distance between the autonomous vehicle and the charging station sending wirelessly power to the autonomous vehicle. In this way, the amount of sensed power or magnetic field may be (re) used as localization data related to the relative position between the autonomous vehicle and the charging station. The amount of received power may further be monitored for monitoring the charging of the energy storage unit.

According to a preferred embodiment, the wireless charging unit comprises a coil, and the power sensing unit is a current sensor, wherein when the sensed current flowing the coil exceeds a predetermined threshold, a signal is generated indicating that the vehicle is precisely above the charging station. In this way, a simple current sensor may be used both for monitoring the charging of the energy storage unit and for the navigation update.

According to a preferred embodiment, the autonomous vehicle further comprises at least one sensor for generating further localization related data. In this way, the accuracy of the navigation may be further improved based on additional sensing data taken from the environment.

According to a preferred embodiment, the at least one sensor is configured to sense the passing of fixed objects in the environment. In this way, the vehicle may be able to update its location based on the preestablished knowledge of the locations of fixed objects in the environment. Alternatively, the at least one sensor is configured to sense the passing of moving objects in the environment, for instance other autonomous vehicles or humans. In this way, the autonomous vehicle may take into account the movements of other moving objects in its proximity.

According to a preferred embodiment, the at least one sensor is a camera is configured to sense the passing of a color mark on the ground, preferably a blue mark on the ground. A color mark in the environment, preferably on the ground, may for instance indicate a pre-established characteristic in the environments like a center part of a navigation path, a crossing of paths, the beginning and/or the end of a path, an alignment with a path. All colors may be used, however blue is the color the least naturally present in nature, such that using a blue mark may avoid false detections.

According to a preferred embodiment, the at least one sensor is configured to sense the regular passing of regularly spaced objects in the environment. In this way, information about the position and speed of the autonomous vehicle may be obtained, to complement the already available data.

According to a preferred embodiment, the at least one sensor is a LIDAR configured to sense the passing of growing media in a greenhouse, for instance plant beds. In this way, the precise positioning of the autonomous vehicle with respect to the growing medium and a measurement of the speed of the vehicle can be achieved.

According to a preferred embodiment, the at least one sensor is selected among one or more of the following: a LIDAR, a radar, an accelerometer, an inertial measuring unit, a speed sensor, a proximity sensor, a camera.

According to a preferred embodiment, the autonomous vehicle further comprises a network communication unit for communicating with a network system, wherein the network communication unit is configured to receive at least the localization related data of the localizing unit and/or the data from the at least one sensor, to send said data to the network system and to receive in return control data from the network system. In this way, the localization related of the localizing unit and/or the data from the at least one sensor may be communicated to an external network and the navigation data may be processed at network level to simplify the amount of processing required on board the autonomous vehicle. Alternatively, the communication with a network system may be to complement a vehicle-based processing, for instance to take into account other autonomous vehicles evolving as well in the indoor agricultural environment as a swarm. It is noted that the autonomous vehicle may also be able to operate independently of this network system.

According to a preferred embodiment, the autonomous vehicle further comprises a control unit configured to receive control data from the communication unit and/or localization related data from the localizing unit and/or from the at least one sensor and to control the motor based thereon. In this way, the motor moving the vehicle may be controlled either locally or via the network.

According to a preferred embodiment, the autonomous vehicle further comprising a housing for housing at least the energy storage unit, the motor, the wireless charging unit and the localization unit, and a clearing unit for clearing debris off an upper surface of the charging station when the vehicle moves above the charging station, preferably a brush attached to the under surface of the housing to brush off an upper surface of the charging station when the vehicle moves above the charging station. Alternatively, a clearing unit for clearing debris using pressurized air may be used. In this way, while moving over the charging station, any dirt or obstacles may be cleared away such that the distance between the vehicle and the charging station may be minimum to achieve an efficient wireless charging.

According to a preferred embodiment, the autonomous vehicle is an autonomous mobile robot (AMR), preferably comprising an arm for performing an agricultural task and/or comprising a conveyor/logistics unit and/or comprising one or more sensors for measuring one or more plant characteristics. In this way, several functions may be performed, among which deleafing (removal of leaves), growth supervision, harvesting, packaging the harvest, etc.

According to another aspect of the invention, is provided an autonomous indoor environment vehicle system, comprising one or more than one charging station and one or more than one autonomous vehicle according to any of the above embodiments.

According to a preferred embodiment, a charging station is located in between rows of plants in a greenhouse navigated by the vehicles. In this way, an efficient use of the greenhouse space may be achieved, since the charging station is placed in a travelled area and not in a dedicated charging area. In addition placing the charging stations in between the rows avoids travels that do not have an agricultural purpose since charging may be performed in between agricultural tasks.

According to a preferred embodiment, the system further comprises a central controller configured to receive data from the one or more autonomous vehicles to process said data and send control data in return to the one or more autonomous vehicles regarding at least how to navigate through the indoor environment. In this way, a plurality of autonomous vehicle may navigate in a coordinated manner, as a swarm, through the environment.

According to a preferred embodiment, the system further comprises one or more local beacons located in the environment at known locations, with communication means to communicate with the one or more autonomous vehicles. In this way, local beacons may act as additional navigation reference points in the environment to improve the accuracy of the navigation.

According to a preferred embodiment, a charging station for wireless charging an autonomous comprises a wireless power sending unit for wirelessly sending power to the autonomous vehicle, a housing configured to be adjustable at least in height to ensure wireless energy transfer in any environment. In this way, a charging station may be easily retrofitted to any environment.

According to a preferred embodiment, the housing is adjustable in width and/or the housing is dust proof and/or waterproof. In this way, the charging station is rendered suitable for the agricultural indoor environment

According to another aspect of the invention, a method for operating an autonomous vehicle is provided for autonomous navigation in an agricultural indoor environment:
moving the vehicle through the indoor environment using energy from the energy storage unit,
when in range of an external charging station, wireless charging the energy storage unit and/or generating data to update the localization of the vehicle within the indoor environment based on the known location of the charging station.

In this way, a method for operating an autonomous vehicle may be simplified by allowing two operations when in range of the external charging station. When both operations are performed simultaneously, namely charging and updating the navigation, the efficiency may be increased.

According to a preferred embodiment, generating data to update the localization of the vehicle comprises receiving information from the wireless charging unit related to the localization of the vehicle in the indoor environment with respect to the charging station. In this way, the navigation update may be realized in a simple manner using the charging station as a reference point,

According to a preferred embodiment, generating data to update the localization of the vehicle comprises sensing the amount of power received and/or the magnetic field generated by the wireless charging unit and generating, based on the sensed power and/or magnetic field, data related to the distance between the autonomous vehicle and the charging station sending wirelessly power to the autonomous vehicle. In this way, the amount of power received may be (re) used as localization data related to the relative position between the autonomous vehicle and the charging station. The amount of received power may further be monitored for monitoring the charging of the energy storage unit

According to a preferred embodiment, sensing the amount of power received by the wireless charging unit comprises sensing a current flowing in a coil of the wireless charging unit, and wherein generating, based on the sensed power, data related to the distance between the autonomous vehicle and the charging station sending wirelessly power to the autonomous vehicle comprises detecting when the sensed current exceeds a predetermined threshold, generating a signal indicating that the vehicle is precisely above the charging station. It is further noted that an additional proximity sensor may also be included in the charging plate as an additional means of localizing the autonomous vehicle above the charging plate—in addition to the sensed power and/or magnetic field.

It is noted that although the previous embodiments have been disclosed in the context of an indoor agricultural environment, a skilled person would understand that the teachings of the present invention may be extended to a broad field of applications including among others, other indoor industrial environment, or even outdoor environments as long as the principle behind the invention of combining wireless charging and navigation update may be adapted to the situation.

According to a preferred embodiment, the method further comprises sending at least the localization related data of the localizing unit and/or the data from the at least one sensor to a network system and receiving in return control data from the network system.

This and other aspects of the present invention will now be described in more detail, with reference to the appended drawings showing currently preferred embodiments of the invention, wherein:

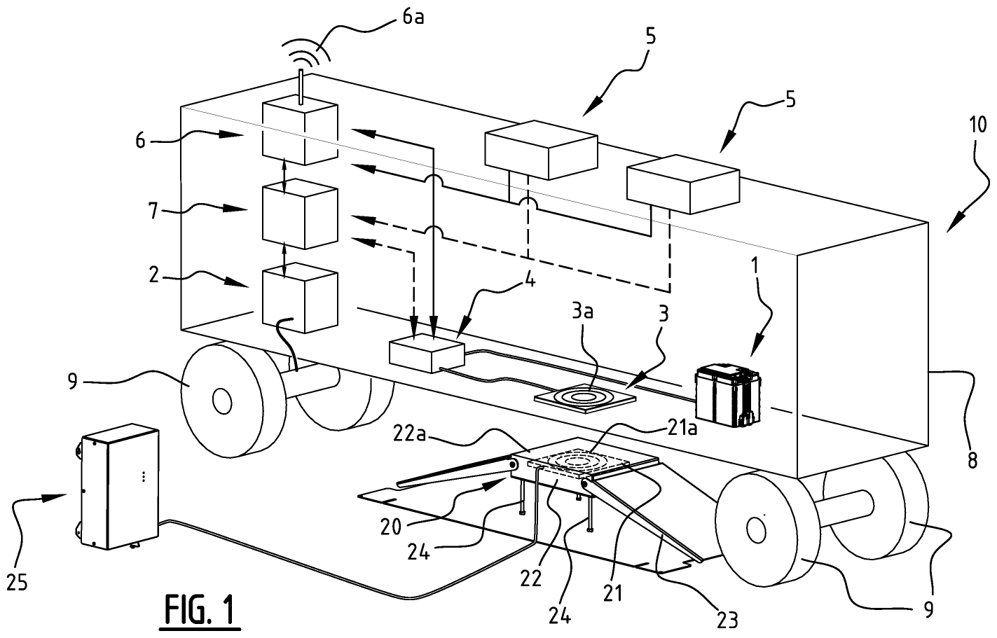

FIG. 1 illustrates a schematic perspective see-through view of an autonomous vehicle, and a charging station according to an embodiment.

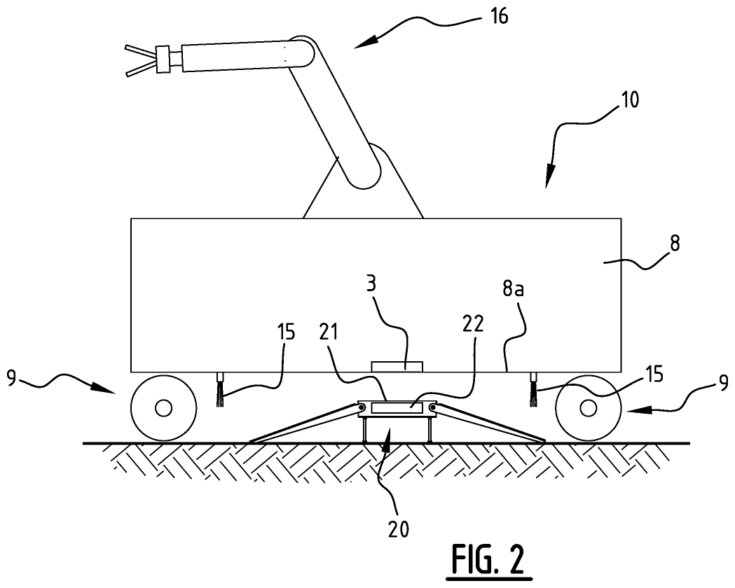

FIG. 2 illustrates a schematic side view of an autonomous vehicle and a charging station according to another embodiment.

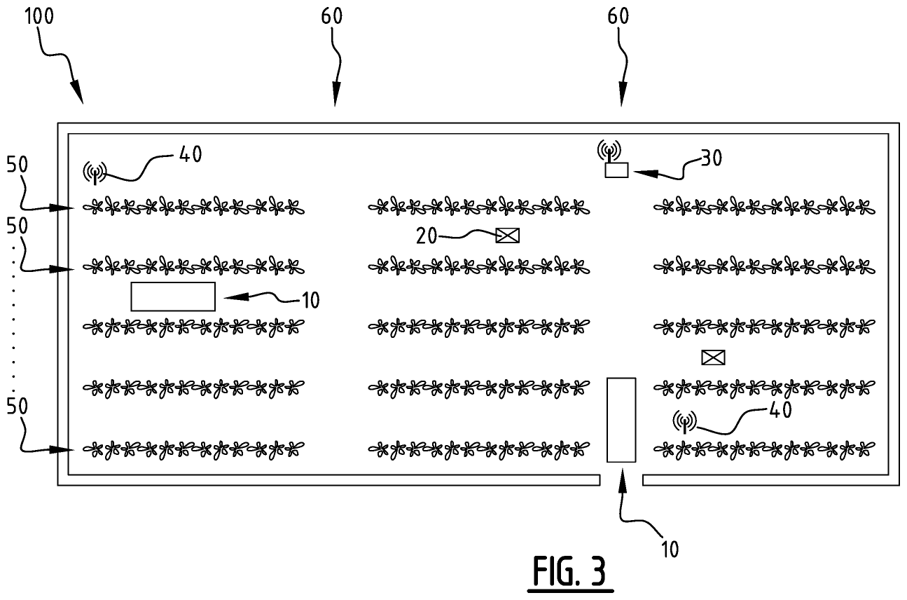

FIG. 3 illustrates a schematic representation of a system according to an embodiment.

FIG. 1 illustrates a schematic perspective see-through view of an autonomous vehicle 10 and a charging station 20 according to an embodiment. The autonomous vehicle 10 is meant for autonomous navigation in an agricultural indoor environment, for instance a greenhouse comprising rows of plant beds in which plants grow. The autonomous vehicle may be a robot travelling through the environment to perform surveillance of the crops, or a mechanical action like deleafing or picking up crops. The autonomous vehicle comprises an energy storage unit 1 for storing electrical energy, a motor 2 for moving the vehicle 10 through the indoor environment using energy from the energy storage unit 1, a wireless charging unit 3 for charging the energy storage unit 1 and a localizing unit 4 configured to generate data to update the localization of the vehicle 10 within the indoor environment based on the known location of the charging station 20. The wireless charging unit 3 is configured to wirelessly receive energy from the external charging station 20. The motor 2 may serve to actuate one or more wheels 9. Other alternatives then wheels may be envisaged as moving parts actuated by motor 2. The motor 2 is typically an electrical motor, powered via a driver receiving power from the energy storage unit 1. The energy storage unit 1 may typically be a battery, for instance Lithium-based battery. Yet other alternatives for storing electrical energy like a capacitor, a super capacitor may be envisaged depending on circumstances.

The wireless charging unit 3 may be located in a lower part of the autonomous vehicle 10. The autonomous vehicle 10 may be configured to move above a charging station 20, such that the wireless charging unit 3 may be arranged above the charging station at a distance enabling wireless charging. The autonomous vehicle 10 may comprise a housing 8. The wireless charging unit 3 may comprise a flat coil 3a. The wireless charging unit 3 may be arranged inside the housing 8, in close proximity with a bottom surface 8a of the housing 8, for instance on the bottom surface 8a.

The charging station 20 may comprise a power sending unit 21. The charging station 20 may comprise a housing 22 with an upper surface 22a. The power sending unit 21 may be enclosed in the housing 22. The power sending unit 21 may comprise a flat coil 21a, arranged under the upper surface 22a. The height of charging station 20 from the ground to the upper surface 22a of the charging station 20 may be lower than the height of the under-clearance of the autonomous vehicle 10, where the height of the under-clearance of the autonomous vehicle 10 is measured between ground and the bottom surface 8a. In this way, the autonomous vehicle 10 may drive over the charging station 20. The width between the wheels of the autonomous vehicle 10 may be dimensioned to accommodate the charging station 20 in between the wheels 9. The autonomous vehicle 10 may in this way drive over the charging station 20 and hoover above the charging station 20 such that the upper surface 22a of the charging station 20 may come in close proximity with the bottom surface 8a. In this way the wireless charging unit 3 may come in close proximity with the power sending unit 4, and energy may be transferred from coil 21a to coil 3a.

The charging station 20 may further comprise two inclined panels 23 from the upper surface 22a of the housing 22 to the ground. The inclined panes 23 and the upper surface 22a of the housing 22 may be used as a pedestrian walkway over the charging station. The charging station may further comprise legs 24, which may be for instance adjustable in length to adjust the height of the charging station. In this way, the charging station may be easily retrofitted in any environment and its height may be adapted to a given under-carriage clearance. The charging station 20 may further comprise a base unit 25 connected to a mains and configured to transform and condition power from the mains to the power sensing unit 4.

The localizing unit 4 may be configured to communicate with the wireless charging unit 3. In particular the localizing unit 4 may be configured to receive information from the wireless charging unit 3 related to the localization of the vehicle 10 in the indoor environment with respect to the charging station 20. The localizing unit may comprise for example a power sensing unit configured to sense the amount of power received by the wireless charging unit 3 and to generate, based on the sensed power, data related to the distance between the autonomous vehicle 10 and the charging station 20. The power sensing unit may be a current sensor. When the sensed current flowing the coil 3a exceeds a predetermined threshold, a signal may be generated indicating that the vehicle 10 is precisely above the charging station 20. The localizing unit 4 may be connected in between the wireless charging unit 3a and the energy storage unit 1 and serve optionally as a power converter converting power from the wireless charging unit 3 to the energy storage unit 1 as illustrated in FIG. 1. Yet in other embodiments, the power transfer between the wireless charging unit 3 and the energy storage unit 1 may be performed outside of the localizing unit 4, while the localizing unit may still receive data from the wireless charging unit 3 related to the localization of the vehicle 10 in the indoor environment with respect to the charging station 20. It is noted that although not represented in FIG. 1, power from the energy storage unit 1 may be internally distributed to all the component of the autonomous vehicle 10 requiring electrical power as commonly known in the art. The arrows used in FIG. 1 are in that context illustrative of data exchange rather than electrical power exchange.

The autonomous vehicle may further comprise a plurality of sensors 5 for generating further localization related data. Two sensors 5 have been illustrated in FIG. 1. Yet the number of sensors may be adapted depending on circumstances to meet the sensing requirements. One sensor 5 may be configured to sense the passing of fixed objects in the environment. According to an embodiment, such a sensor 5 may be a camera configured to sense the passing of a color mark on the ground, preferably a blue mark on the ground. The color blue may be selected because unlikely to be present in the agricultural environment since blue comes little for in nature. A color mark in the environment, preferably on the ground, may for instance indicate a pre-established characteristic in the environments like a center part of a navigation path, a crossing of paths, the beginning and/or the end of a path, an alignment with a path. The camera may then be mounted on the autonomous vehicle to observe the environment and may detect a color mark present along the path navigated by the autonomous vehicle 10 and send data in accordance with the detection to a network communication unit 6 or any other internal or external communication device.

According to an embodiment, one sensor 5 may be configured to sense the regular passing of regularly spaced objects in the environment. In particular, one sensor 5 may be a LIDAR configured to sense the passing of growing media, or more specifically plant beds in a greenhouse. Since plants beds are regularly placed in a row, the alternance between a plant bed and no plant bed may be used as an additional speed or position information to precise the location of the vehicle 10 in its environment.

The at least one sensor may yet be selected among one or more of the following: a LIDAR, a radar, an accelerometer, a speed sensor, a proximity sensor, a camera.

According to an embodiment, one sensor 5 may be configured to sense the passing and/or the location of the charging station. In particular the one sensor 5 may be an Infrared sensor configured to detect a marker on a charging station.

As illustrated in FIG. 1, the autonomous vehicle 10 may further comprise a network communication unit 6 for communicating with an external network system (not illustrated in FIG. 1 but in later in FIG. 3). The network communication unit 6 may be configured to receive at least the localization related data of the localizing unit 4 and/or the data from the at least one sensor 5, to send said data to the external network system and to receive in return control data from the external network system. The network communication unit 6 may use one or more of a short-range, medium-range or a long-range communication technique or a combination thereof. In an alternative embodiment represented using dotted arrows, the network communication unit 6 may be optional and the autonomous vehicle 10 may be able to navigate on its own.

The autonomous vehicle 10 may further comprise a control unit 7 configured to receive control data from the communication unit 6 and/or localization related data from the localizing unit 4 and/or from the at least one sensor 5 and to control the motor 2 based thereon. The control unit 7 may control the movement of the vehicle 10 based on a navigation target. The navigation target may be derived among others from the localization data from the localizing unit 4 and/or from the at least one sensor 5.

As further illustrated in FIG. 1, the autonomous vehicle 10 may comprise a housing 8 for housing at least the energy storage unit 1, the motor 2, the wireless charging unit 3 and the localization unit 4. In FIG. 2 an alternative is disclosed in which a clearing unit in the form of brushes 15 may be attached to the under surface 8a of the housing 8 to brush debris off an upper surface 22a of the charging station 20 when the vehicle 10 moves above the charging station 20.

In an embodiment, the autonomous vehicle 10 may be an autonomous mobile robot (AMR), preferably comprising an arm for performing an agricultural task and/or comprising a conveyor/logistics unit and/or comprising one or more sensors for measuring one or more plant characteristics.

FIG. 3 illustrates a schematic representation of a system according to an embodiment. The autonomous indoor environment vehicle system of FIG. 3 comprises one or more than one charging stations 20 and one or more than one autonomous vehicles 10 described previously in an indoor agricultural environment 100, typically a greenhouse environment. The environment 100 may comprise rows and columns of plant beds 50. The vehicles 10 may typically navigate in between the rows 50 and on alleys 60 communicating between rows 50. The environment 100 may be mapped prior to the start of the navigation of the vehicles 10 and the location of the charging stations 20 may be stored, for instance in a database. A charging station 20 may typically be located in between rows of plants in a greenhouse. Alternatively a charging station 20 may be located in an alley communicating between rows of plants. Preferably the charging station may be located at a location the vehicle would navigate during its normal operation, namely not solely for charging itself. In this way, the charging process may be performed during normal operation, avoiding unnecessary travels to a purely charging location.

The system may further comprise a central controller 30 configured to receive data from the one or more autonomous vehicles 10 to process said data and send control data in return to the one or more autonomous vehicles 10 regarding at least how to navigate through the indoor environment 100.

The system may further comprise one or more local beacons 40 located in the environment at known locations, comprising communication means to communicate with the one or more autonomous vehicles 10. The location of the one or more beacons 40 may also be known in advance and preferably store in a dedicated database.

A charging station 20 for wireless charging an autonomous may in such a system comprise a wireless power sending unit 21 for wirelessly sending power to the autonomous vehicle, and a housing 22 configured to be adjustable at least in height to ensure wireless energy transfer in any environment. The housing may be adjustable in width and/or the housing may be pressure roof and/or waterproof.

A method for operating an autonomous vehicle (not illustrated) comprises for autonomous navigation in an agricultural indoor environment:
moving the vehicle through the indoor environment using energy from the energy storage unit,
when in range of an external charging station, wireless charging the energy storage unit and/or generating data to update the localization of the vehicle within the indoor environment based on the known location of the charging station.

Generating data to update the localization of the vehicle may comprise receiving information from the wireless charging unit related to the localization of the vehicle in the indoor environment with respect to the charging station.

Generating data to update the localization of the vehicle may comprise sensing the amount of power received by the wireless charging unit and generating, based on the sensed power, data related to the distance between the autonomous vehicle and the charging station sending wirelessly power to the autonomous vehicle.

Sensing the amount of power received by the wireless charging unit may comprise sensing a current flowing in a coil of the wireless charging unit, and wherein generating, based on the sensed power, data related to the distance between the autonomous vehicle and the charging station sending wirelessly power to the autonomous vehicle comprises detecting when the sensed current exceeds a predetermined threshold, generating a signal indicating that the vehicle is precisely above the charging station.

The method may in addition comprise sending at least the localization related data of the localizing unit and/or the data from the at least one sensor to a network system and receiving in return control data from the network system.

Whilst the principles of the invention have been set out above in connection with specific embodiments, it is understood that this description is merely made by way of example and not as a limitation of the scope of protection which is determined by the appended claims.

1. An autonomous vehicle for autonomous navigation in an agricultural indoor environment, comprising:
an energy storage unit for storing electrical energy,
a motor for moving the autonomous vehicle through the agricultural indoor environment using energy from the energy storage unit,
a wireless charging unit for charging the energy storage unit, the wireless charging unit configured to wirelessly receive energy from an external charging station, and
a localizing unit configured to generate data to update the localization of the autonomous vehicle within the agricultural indoor environment based on the known location of the charging station.

2. The autonomous vehicle of claim 1, wherein the localizing unit is configured to receive information from the wireless charging unit related to the localization of the vehicle in the agricultural indoor environment with respect to the charging station.

3. The autonomous vehicle of claim 1, wherein the localizing unit comprises a power sensing unit configured to sense the amount of power received by the wireless charging unit and to generate, based on the sensed power, data related to the distance between the autonomous vehicle and the charging station.

4. The autonomous vehicle of claim 3, wherein the wireless charging unit comprises a coil, and wherein the power sensing unit is a current sensor, wherein when the sensed current flowing the coil exceeds a predetermined threshold, a signal is generated indicating that the vehicle is precisely above the charging station (20).

5. The autonomous vehicle of claim 1, further comprising at least one sensor for generating further localization related data.

6. The autonomous vehicle of claim 5, wherein the at least one sensor is configured to sense the passing of fixed objects in the environment; and/or
wherein the at least one sensor is a camera is configured to sense the passing of a color mark on the ground; and/or
wherein the at least one sensor is configured to sense the regular passing of regularly spaced objects in the environment; and/or
wherein the at least one sensor is selected among one or more of the following: a LIDAR, a radar, an accelerometer, an inertial measurement unit, a speed sensor, a proximity sensor, a camera.

7. The autonomous vehicle of claim 1, further comprising a network communication unit for communicating with a network system, wherein the network communication unit is configured to receive at least the localization related data of the localizing unit and/or the data from the at least one sensor, to send said data to the network system and to receive in return control data from the network system.

8. The autonomous vehicle of claim 1, further comprising a control unit configured to receive control data from the communication unit and/or localization related data from the localizing unit and/or from the at least one sensor and to control the motor based thereon.

9. The autonomous vehicle of claim 1, the autonomous vehicle further comprising:
a housing for housing at least the energy storage unit, the motor, the wireless charging unit and the localization unit, and
a clearing unit (15) for clearing debris off an upper surface of the charging station when the vehicle moves above the charging station (20.

10. The autonomous vehicle of claim 1, wherein the autonomous vehicle is an autonomous mobile robot (AMR.

11. An autonomous indoor environment vehicle system, comprising one or more than one charging station and at least one autonomous vehicle according to claim 1.

12. The system of claim 11, wherein the agricultural indoor environment comprises one or more rows of plants defining in between them navigation paths along which a vehicle navigates and wherein a charging station is located along a navigation path.

13. The system of claim 11, further comprising a central controller configured to receive data from the one or more autonomous vehicles to process said data and send control data in return to the one or more autonomous vehicles regarding at least how to navigate through the agricultural indoor environment; and/or
further comprising one or more local beacons located in the agricultural indoor environment at known locations, with communication means to communicate with the one or more autonomous vehicles.

14. The system of claim 11, wherein a charging station for wireless charging an autonomous comprises:
a wireless power sending unit for wirelessly sending power to the autonomous vehicle,
a housing configured to be adjustable at least in height to ensure wireless energy transfer in any environment.

15. A method for operating the autonomous vehicle according to claim 1 for autonomous navigation in an agricultural indoor environment, the method comprising:
moving the vehicle through the indoor environment using energy from the energy storage unit, and
when in range of an external charging station, wireless charging the energy storage unit and/or generating data to update the localization of the vehicle within the agricultural indoor environment based on the known location of the charging station.

16. The method of claim 15, wherein generating data to update the localization of the vehicle comprises receiving information from the wireless charging unit related to the localization of the vehicle in the agricultural indoor environment with respect to the charging station; and/or
wherein generating data to update the localization of the vehicle comprises sensing the amount of power received by the wireless charging unit and generating, based on the sensed power, data related to the distance between the autonomous vehicle and the charging station sending wirelessly power to the autonomous vehicle, and wherein generating, based on the sensed power, data related to the distance between the autonomous vehicle and the charging station sending wirelessly power to the autonomous vehicle comprises detecting when the sensed current exceeds a predetermined threshold, generating a signal indicating that the vehicle is precisely above the charging station.

17. The method of claim 15, further comprising sending at least the localization related data of the localizing unit and/or the data from the at least one sensor to a network system and receiving in return control data from the network system.

18. The autonomous vehicle of claim 1, wherein based on the pre-established knowledge of the location of the charging station, the localization of the vehicle is updated when the vehicle is at the charging station.

19. Autonomous vehicle for autonomous navigation, comprising:
an energy storage unit for storing electrical energy,
a motor for moving the autonomous vehicle using energy from the energy storage unit,
a wireless charging unit for charging the energy storage unit, the wireless charging unit being configured to wirelessly receive energy from an external charging station, and
a localizing unit configured to generate data to update the localization of the autonomous vehicle based on the known location of the charging station
wherein the localizing unit is configured to derive a distance between the autonomous vehicle and the charging station based on the amount of power received by the wireless charging unit.

20. The autonomous vehicle of claim 19, wherein the localizing unit is configured to derive the distance between the autonomous vehicle and the charging station from a value of a current flowing in a charging coil of the wireless charging unit.
